(19) United States
(12) Patent Application Publication
(10) Pub. No.: US 2008/0223703 A1
(43) Pub. Date: Sep. 18, 2008

(54) MULTIFUNCTIONAL OPERATING ELEMENT

(76) Inventors: Harald Schelbert, Bad Koenigshofen (DE); Stefan Schuberth, Bad Neustadt (DE)

Correspondence Address: Muncy, Geissler, Olds & Lowe, PLLC, P.O. BOX 1364, FAIRFAX, VA, 22038-1364, US

(21) Appl. No.: 12/014,740

(22) Filed: Jan. 15, 2008

Related U.S. Application Data
(63) Continuation of application No. PCT/EP2006/006411, filed on Jul. 1, 2006.

(30) Foreign Application Priority Data
Jul. 15, 2005 (DE) DE10 2005 033 126
Nov. 30, 2005 (DE) DE10 2005 057 023

(51) Int. Cl. H01H 3/04

(52) U.S. Cl. 200/335

(57) ABSTRACT

The haptic feedback of a tilt is resource-intensive to produce for conventional operating elements. Consequently, the invention provides an operating element whose tilt haptics are easy and economical to produce. This is achieved by the means that a ball can be moved against an elastic element in the direction of the longitudinal axis of the lever, and in that the ball can also be supported in a detent arranged in a housing in order to produce the haptic feedback.

This nonprovisional application is a continuation of International Application No. PCT/EP2006/006411, which was filed on Jul. 1, 2006, and which claims priority to German Patent Applications No. DE 102005033126 and DE 102005057023, which were filed in Germany on Jul. 15, 2005 and Nov. 30, 2005, respectively, and which are both herein incorporated by reference.

### BACKGROUND OF THE INVENTION

1. Field of the Invention

The present invention relates to an operating element for electrical switching according.

2. Description of the Background Art

Operating elements, which are designed as joysticks or rocker switches, are used in automobiles, for example, in order to perform electrical switching operations and/or to initiate functions. They are used to operate navigation and/or audio systems, for example.

From DE 200 14 425 U1 an operating knob control device is known, in which an operating knob is mounted so as to be rotatable and tiltable. Rotary and tilting motions are each detected by a sensor. Rotary haptics are produced by means of an electric motor, for example; tilt haptics can be provided through magnets, for example. Producing the haptics is very resource-intensive.

DE 100 21 895 A1, which corresponds to U.S. Pat. No. 7,061,466, describes a joystick device with force feedback for inputting control signals to a computer and for outputting forces to a user of the device, wherein a housing is held by a user and the force feedback (haptics) is produced by actuators with direct drive. Here, too, producing the haptics is very resource-intensive.

DE 100 42 028 A1 discloses a multifunctional operating device with at least one external and one internal adjusting element. The external adjusting element is mounted such that it can rotate about an axis, and has an aperture. The internal adjusting element can be reached through the aperture from outside. No specific haptics of the adjusting elements are described.

### SUMMARY OF THE INVENTION

It is therefore an object of the present invention to provide an operating element for electrical switching in which tilt haptics are achieved with simple mechanical means.

In an embodiment, a ball can be moved against an elastic element in the direction of the longitudinal axis of the lever, and can also be supported in a detent arranged in the housing in order to produce haptic feedback. By this means, the tilt haptics are achieved in a purely mechanical way. Costly electrical/electronic means, with corresponding controls, for producing the haptics are not required. The lever and the haptics are guided essentially without play, achieving precise actuation of the devices being operated. In the unactuated state, the lever automatically centers itself in a central neutral position.

The guidance of the ball in the at least partially hollow lever requires very little space.

In the case of a coil spring as the elastic element, the spring force can be adjusted especially well.

When, in an embodiment, a recess is let into the ball in which a pin is supported that is guided in the lever, relative movement between the ball and the detent is prevented. Accordingly, the ball rolls in the detent instead of sliding in it. Especially favorable haptic feedback with little wear can be achieved by this means.

Guiding of the ball with downward preloading by three pressure rollers attached to the lever is another easily produced embodiment of the invention.

A detent, whose sides have variable slopes in cross-section, has proven especially suitable. Preferably, the sides have slopes that are constant in sections.

A rotationally symmetric design of the detent permits haptic feedback for the lever that is the same in every direction of tilt. Alternatively, haptic feedback that depends on the direction of tilt, for example for distinguishing between primary and secondary directions of tilt, can be achieved through a design of the slope profile of the detent that differs in different directions of the ball.

When the lever is combined with an operating knob, the operating element is versatile in use and permits a variety of switching variations. It is then particularly suitable for operating navigation units and/or audio systems, for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a normal section through an inventive operating element for electrical switching,

FIG. 2 illustrates an enlarged detail from FIG. 1 with a lower end of a lever, and,

FIG. 3 illustrates an enlarged detail from FIG. 2 and a haptic pattern of the lever as a distance/force curve.

### DETAILED DESCRIPTION

In the following description, position references refer to the representation in the figures. In the installed state, the operating element can have any desired position, in which these position references would then no longer apply.

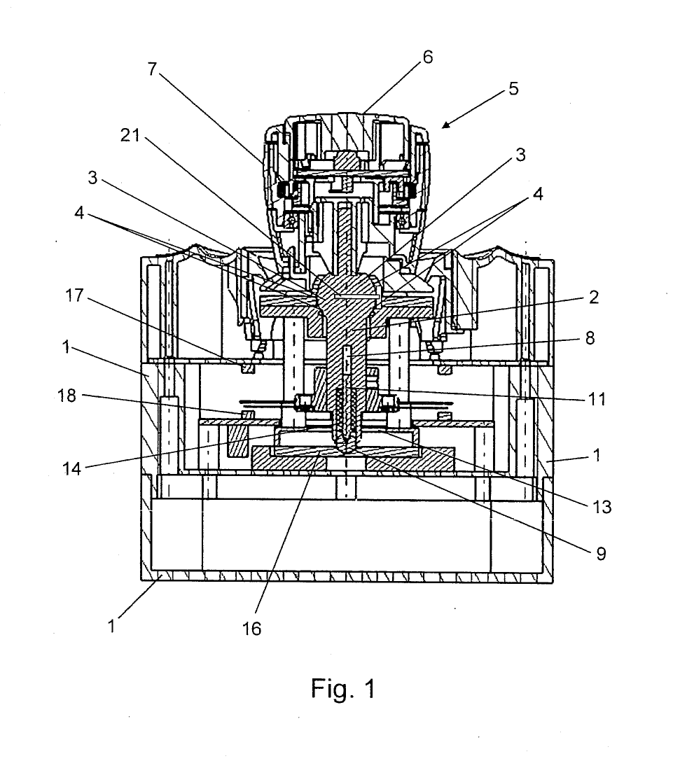

As is evident from FIG. 1, a lever 2 is supported in articulated fashion in a housing 1. For this purpose, part of the upper half of the lever 2 is enlarged in the shape of a ball, wherein this enlargement 3 is supported in an appropriate bushing 4 with very little play such that the lever 2 can tilt about a center of rotation within the bushing 4. Rotation of the lever 2 about its longitudinal axis is prevented by means of a pin 21 placed axially through the center of rotation of the enlargement. In addition, the lever 2 is guided beneath the enlargement 3 in a cross-shaped switching gate 13, which is attached in the housing 1 and permits four directions of tilt of the lever 2 here, with a right angle being formed between two adjacent directions of tilt.

An operating knob 5 with a circular cross-section is attached to an upper end of the lever 2 in a rotationally fixed manner. A pushbutton 6 and a rotating ring 7 are integrated in the operating knob 5. The pushbutton 6 includes means for switching; the rotating ring 7 corresponds to a means for determining the rotary travel—such as an encoder disk and a branched optical interrupter.

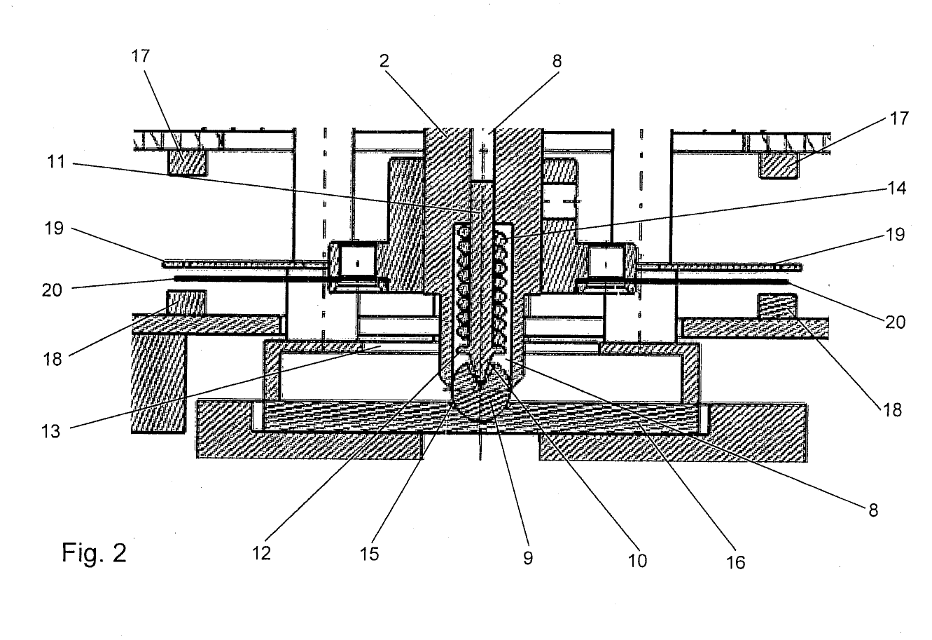

As can be seen especially well in FIG. 2, a bottom end of the lever 2 is equipped with a sleeve in the form of a bore 8, which is concentric to the longitudinal axis of the lever 2 and has a circular cross-section. In this way, the bore 8 has two different diameters, with the larger of the diameters of the bore 8 beginning at the bottommost end of the lever 2 and the smaller diameter adjoining after a certain distance while forming a shoulder.

A ball 9 is supported in the lower end of the bore 8 with little play. The ball 9 has an upward-facing conical aperture 10. Placed in the aperture 10 is the conical tip of a pin 11, which has a smaller generating angle than the aperture 10, so that rotary movement of the ball 9 about the tip of the pin 11 is possible. The pin 11 is guided in the bore 8 and extends to the section of the bore 8 with a smaller diameter. The pin 11 has a circular cross-section that fits into the smaller diameter bore with little play. Arranged between the tip and the cylindrical part of the pin 11 is a plate-like projection 12.

A coil spring 14 is supported on the pin 11 in such a manner that it bears against the projection 12 at one end, and at an opposite end bears against the shoulder formed between the different diameters of the bore 8.

In the housing 1, a detent 15 for producing haptic feedback is arranged such that, when the lever 2 is in a vertical neutral position, the center point of the detent 15 is located below the lever 2 in an extension of the longitudinal axis of the lever 2. The detent 15 is let into a plate 16 that is mounted in the housing 1. An area around the center point of the detent 15, whose size is approximately one third the diameter of the ball 9, is horizontal.

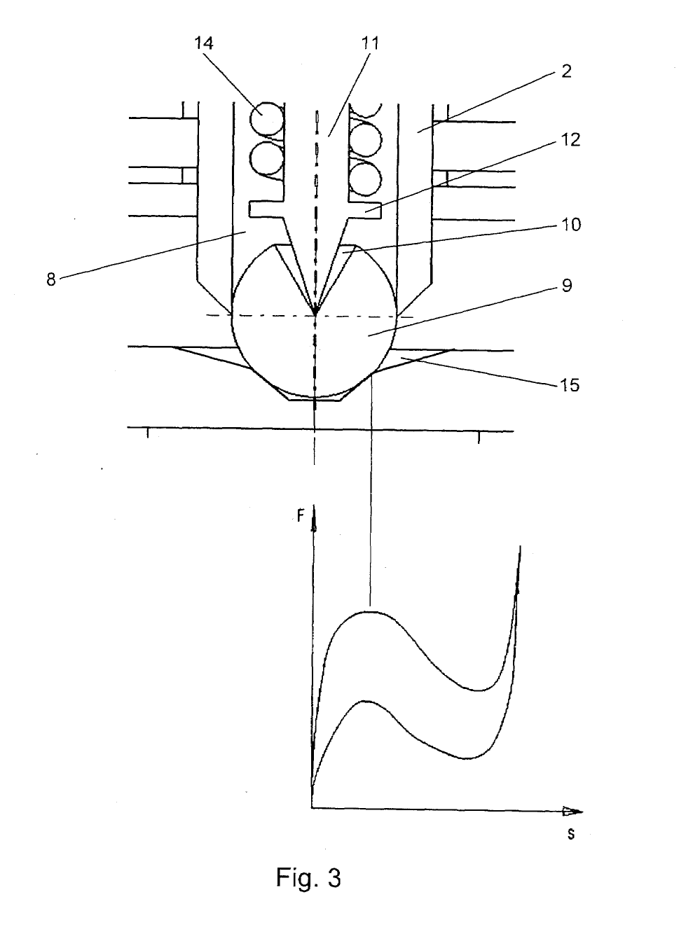

The detent 15 is designed as a rotationally symmetric, truncated cone, whose generating angle varies over its height. In the section shown in FIG. 3, the side of the detent 15 initially climbs with a constant slope after the horizontal section when viewed from the axis of rotation. This is then adjoined by an area with a side slope that is also constant, but smaller. The possible directions of movement of the ball 9 within the detent 15, and thus the tilt directions of the lever 2, are determined by the switching gate 13.

As an alternative to the rotationally symmetric design, the detent 15 has four grooves arranged in the form of a cross starting from its center point. In this design, the orientation of the grooves corresponds to the switching gate 13. Each of the grooves originates from this area and is semicircular in cross-section corresponding to the diameter of the ball 9. In longitudinal section, each groove consists of two sections with different constant slopes, wherein the slope in the area oriented toward the center point of the detent 15 is greater than in the area facing away from the center point. The freedom of motion of the ball 9, and thus of the lever 2, can be determined by the shape of the detent 15, so that the switching gate 13 is optional.

The ball 9 rests in the area around the center point of the detent 15 when the lever 2 is in the neutral position, and it rolls along the side of the detent 15 when the lever 2 is tilted. In so doing, the ball 9 is pressed into the detent 15 by the spring 14 via the pin 11.

In order to be able to sense tilting motions of the lever 2, means for determining the tilting motions are arranged on the lever and in its surroundings. For this purpose, four light sources 17 and four phototransistors 18, corresponding to the number of possible directions of tilt of the lever 2, are attached in the housing 1, as are associated rigid perforated plates 19, which extend horizontally into the space between the light sources and phototransistors. Masks 20 are arranged on the lever 2 such that they are parallel to the perforated plates 19, and when the lever 2 is in the neutral position they are between the lever and the phototransistors 18. Each of the perforated plates 19 and masks 20 is designed in the form of an annular disk or cross, for example, with recesses being let into the perforated plates 19 which either permit light to pass from one of the light sources 17 to the associated phototransistor 18 or not when the lever 2 is in the appropriate position with respect to the masks 20. The phototransistors 18 are connected to means for evaluation and/or switching.

In order to prevent improper switching, means for blocking the tilting motions of the lever 2 can be provided. For this purpose, for example, actuators are mounted in the housing 1, which lock a corresponding direction of motion of the lever 2 only when in the activated state.

Additional switches may be located on the top of the housing 1.

When the operating element is operated, the lever 2 is tilted by means of the operating knob 5 into one of the predetermined directions of tilt. In the process, the ball 9 rolls in the detent 15, with the result—depending on the shape of the side of the detent 15—that a distance/force curve is produced such as is shown schematically in FIG. 3. In this figure, S designates the excursion of the lever 2, and F designates the force to be applied for further tilting. The force required for tilting, which is reproduced in the upper curve, initially rises steeply to a maximum value, then drops somewhat, and then rises again as a result of an end stop for the tilting motion. When released, the resulting force characteristic corresponds to the lower curve. The haptic feedback can be defined by choosing the spring force and/or the shape of the sides in accordance with requirements, wherein the shape of the curve depends primarily on the shape of the sides of the detent 15 and the force, from the properties of the spring 14, that must be applied to overcome the local maximum of the force characteristic.

Detection of the tilting motions takes place in a known manner with the aid of the light sources 17, phototransistors 18, perforated plates 19, and masks 20.

Additional switching functions can be performed by means of the rotating ring 7, the pushbutton 6, and the other switches.

As an alternative to the example described above, the ball 9 is pressed into the detent 15 by three pressure rollers. The pressure rollers are fastened concentrically to the lever 2 such that their centers form an equilateral triangle and such that the pressure rollers engage the upper half of the ball. At least one of the pressure rollers is preloaded against the ball.

The example embodiments relate to levers 2 that permit four directions of tilt. The invention also applies to levers that permit a different number of directions of tilt. In principle, the edge shapes of the detent 15, and thus the haptic feedback, can be determined individually for each direction of tilt.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An operating element for electrical switching comprising:
a housing;
a lever mounted such that it can tilt within the housing, the lever being guided within a switching gate and one end of the lever being guided in the housing by a ball; and
determination device for determining the tilting motion and/or the tilt position,
wherein the ball is moved against an elastic element in a direction of a longitudinal axis of the lever, and
wherein the ball is guided in a detent arranged in the housing in order to produce haptic feedback.

2. The operating element according to claim 1, wherein the ball is supported in the lever, which is at least partially hollow.

3. The operating element according to claim 1, wherein the elastic element is a coil spring.

4. The operating element according to claim 1, wherein the ball has a recess in which is supported a pin that is guided in the lever.

5. The operating element according to claim 1, wherein the ball is guided with downward preloading by three pressure rollers attached to the lever.

6. The operating element according to claim 1, wherein at least one side of the detent has a variable slope in a longitudinal cross-section.

7. The operating element according to claim 1, wherein the detent is rotationally symmetric in design.

8. The operating element according to claim 1, wherein an operating knob is attached to an upper end of the lever in a rotationally fixed manner.
